(19) United States
(12) Patent Application Publication
(10) Pub. No.: US 2022/0356405 A1
(43) Pub. Date: Nov. 10, 2022

(54) HIGH-DENSITY FLUIDIZED BED SYSTEMS HEAT BALANCE

(71) Applicant: SABIC Global Technologies B.V., Bergen op Zoom (NL)

(72) Inventors: Talal Khaled AL-SHAMMARI, Riyadh (SA); Ernesto UEHARA, Riyadh (SA)

(73) Assignee: SABIC Global Technologies B.V., Bergen op Zoom (NL)

(21) Appl. No.: 17/628,797

(22) PCT Filed: Jun. 30, 2020
(86) PCT No.: PCT/IB2020/056198

§ 371 Date: Jan. 20, 2022

Related U.S. Application Data
(60) Provisional application No. 62/881,242, filed on Jul. 31, 2019.

(51) Int. Cl. C10G 11/18

(52) U.S. Cl. CPC C10G 11/182; C10G 11/187; C10G 2400/20; C10G 2400/30; C10G 2300/104; C10G 2300/1044; C10G 2300/301; C10G 2300/4018; C10G 2300/708; C10G 2300/4006; C10G 2300/4012

(57) ABSTRACT

Methods for catalytic cracking hydrocarbon mixture have been disclosed. A hydrocarbon mixture having an initial boiling temperature of 30° C. to 70° C. is catalytically cracked in the presence of a catalyst to produce one or more olefins and/or one or more aromatics. The catalytic cracking is conducted such that the amount of coke formed on the catalyst is at least 5 wt. % (based on total weight of spent catalyst). The catalyst from the catalytic cracking step is then regenerated to produce regenerated catalyst.

### CROSS REFERENCE TO RELATED APPLICATIONS

This application claims benefit of priority of U.S. Provisional Patent Application No. 62/881,242 filed Jul. 31, 2019, which is hereby incorporated by reference in its entirety.

### FIELD OF INVENTION

The present invention generally relates to processes for producing aromatics and olefins via catalytic cracking. More specifically, the present invention relates to methods of catalytically cracking naphtha that includes monitoring coke content formed on catalyst during the catalytic cracking process and using information from the monitoring to determine when to regenerate the catalyst.

### BACKGROUND OF THE INVENTION

Light olefins (C₂ to C₄ olefins) are building blocks for many chemical processes. Light olefins are used to produce polyethylene, polypropylene, ethylene oxide, ethylene chloride, propylene oxide, and acrylic acid, which, in turn, are used in a wide variety of industries such as the plastic processing, construction, textile, and automotive industries. Generally, light olefins are produced by steam cracking naphtha and dehydrogenating paraffin.

BTX (benzene, toluene, and xylene) are a group aromatics that are used in many different areas of the chemical industry, especially the plastic and polymer sectors. For instance, benzene is a precursor for producing polystyrene, phenolic resins, polycarbonate, and nylon. Toluene is used for producing polyurethane and as a gasoline component. Xylene is feedstock for producing polyester fibers and phthalic anhydride. In the petrochemical industry, benzene, toluene, and xylene are conventionally produced by catalytic reforming of naphtha.

Over the last few decades, the demands for light olefins and BTX have been consistently increasing. Other methods, including catalytic cracking of naphtha, have been explored to produce light olefins and/or BTX to meet the demands. However, the catalytic cracking of hydrocarbons is highly endothermic, and the coke formed on the catalyst is often not sufficient to supply the required amount of heat during the catalyst regeneration process. Thus, it can be difficult to maintain heat balance in the reaction system and prevent temperature drop in the catalytic cracker during catalytic cracking process. Lack of reaction heat in the catalytic cracking reactor can cause low reaction rate, low selectivity to light olefins and BTX, thereby increasing production cost for light olefins and BTX.

Overall, while systems and methods of producing light olefins and BTX via catalytic cracking exist, the need for improvements in this field persists in light of at least the aforementioned drawbacks for the methods.

### BRIEF SUMMARY OF THE INVENTION

A solution to at least some of the above-mentioned problems associated with the systems and methods for catalytic cracking hydrocarbons has been discovered. The solution resides in a method for producing olefins and aromatics that includes regenerating a spent catalyst containing at least 5 wt. % coke. By burning the coke during the catalyst regeneration step, sufficient heat can be restored to the regenerated catalyst. This can be beneficial for at least ensuring that the regenerated catalyst contain sufficient heat for catalytic cracking hydrocarbons. Thus, the disclosed method is capable of preventing temperature drop in the catalytic cracking reactor and/or mitigating the need for adding fuel to the catalytic cracking reactor. Furthermore, the disclosed method can include catalytically cracking hydrocarbons in a fluidized bed with a superficial gas velocity in a range of 2 to 7 m/s, to maintain a target coke content range of the fluidized bed and consequently to maintain heat balance in the catalytic cracking reactor. Moreover, the disclosed method can use a catalytic cracking reactor that includes internal baffles disposed therein to control back mixing and ensure sufficient gas distribution in the fluidized catalyst bed, resulting in improved production efficiency of olefins and aromatics compared to conventional methods. Therefore, the method of the present invention provides a technical solution to at least some of the problems associated with the conventional methods for catalytically cracking hydrocarbons.

Embodiments of the invention include a method of producing olefins and/or aromatics. The method comprises contacting a hydrocarbon mixture having an initial boiling point of 30° C. to 70° C. with catalyst particles of a catalyst bed under reaction conditions effective to produce one or more olefins and/or one or more aromatics. The method comprises regenerating the catalyst particles, in response to coke content of the catalyst bed being at least 5 wt. %.

Embodiments of the invention include a method of producing olefins and/or aromatics. The method comprises contacting a hydrocarbon mixture having an initial boiling point of 30° C. to 70° C. with catalyst particles of a catalyst bed under reaction conditions effective to produce one or more olefins and/or one or more aromatics. The method comprise regenerating the catalyst particles, in response to coke content of the catalyst bed being at least 10 wt. %. The reaction conditions comprises a superficial gas velocity in a range of 2 to 7 m/s.

Embodiments of the invention include a method of producing olefins and/or aromatics. The method comprises contacting a hydrocarbon mixture having an initial boiling point of 30° C. to 70° C. with catalyst particles of a catalyst bed, in a reactor, under reaction conditions effective to produce C₂ to C₄ olefins and/or one or more of benzene, toluene, and xylene. The method comprises determining coke content of the catalyst bed. The method comprises removing the catalyst particles from the reactor. The method comprises regenerating the catalyst particles, in a regenerator, in response to the determined coke content of the catalyst bed being at least 15 wt. %. The reaction conditions comprises a superficial gas velocity in a range of 2 to 7 m/s.

The following includes definitions of various terms and phrases used throughout this specification.

The terms “about” or “approximately” are defined as being close to as understood by one of ordinary skill in the art. In one non-limiting embodiment the terms are defined to be within 10%, preferably, within 5%, more preferably, within 1%, and most preferably, within 0.5%.

The terms “wt. %”, “vol. %” or “mol. %” refer to a weight, volume, or molar percentage of a component, respectively, based on the total weight, the total volume, or the total moles of material that includes the component. In a non-limiting example, 10 moles of component in 100 moles of the material is 10 mol. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprisin2, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process of the present invention can “comprise,” “consist essentially of,” or “consist of” particular ingredients, components, compositions, etc., disclosed throughout the specification.

The term “primarily,” as that term is used in the specification and/or claims, means greater than any of 50 wt. %, 50 mol. %, and 50 vol. %. For example, “primarily” may include 50.1 wt. % to 100 wt. % and all values and ranges there between, 50.1 mol. % to 100 mol. % and all values and ranges there between, or 50.1 vol. % to 100 vol. % and all values and ranges there between.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

For a more complete understanding, reference is now made to the following descriptions taken in conjunction with the accompanying drawings, in which:

FIG. 1 shows a schematic flowchart for a method of producing olefins and/or aromatics, according to embodiments of the invention.

### DETAILED DESCRIPTION OF THE INVENTION

Currently, the catalytic cracking processes for producing olefins and/or aromatics suffer several drawbacks that limit the production efficiency and increase the production for olefins and aromatics. In particular, the catalyst regenerating process of the conventional catalytic cracking methods may not produce sufficient heat for the catalytic cracking process, resulting in low production efficiency for olefins and aromatics. Adding fuel to increase the temperature of the catalyst may be able to mitigate the problem. However, this can increase the production cost for olefins and aromatics and reduce the catalyst stability or catalyst life time. The present invention provides a solution to this problem. The solution is premised. on a method of catalytic cracking hydrocarbons that includes catalytically cracking naphtha until the spent catalyst contains at least 5 wt. % coke, and regenerating the spent catalyst by burning the coke. The heat released from coke burning is used to provide sufficient heat for the catalytic cracking reaction. This disclosed method is capable of mitigating the problem of conventional catalytic cracking processes that gets insufficient reaction heat. Additionally, the catalytic cracking reactor used in the disclosed method can include internal baffles to control the back mixing and gas distribution in the reactor, resulting in improved heat distribution and, consequently, improved production efficiency for olefins and aromatics. These and other non-limiting aspects of the present invention are discussed in further detail in the following section.

Method of Producing Olefins and/or Aromatics

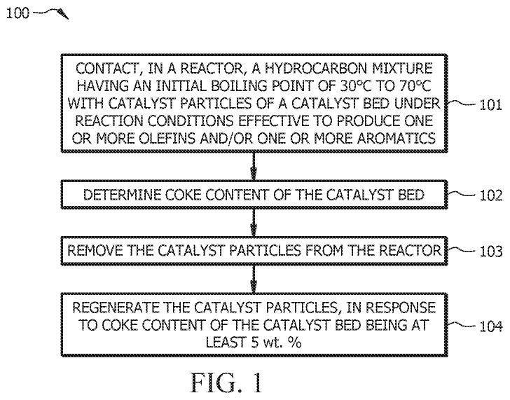

Methods of catalytic cracking hydrocarbons to produce olefins and aromatics have been discovered. The methods may be capable of mitigating the issue of insufficient heat generated by catalyst regeneration for the conventional catalytic cracking processes. As shown in FIG. 1, embodiments of the invention include method 100 of producing olefins and/or aromatics.

According to embodiments of the invention, as shown in block 101, method 100 includes contacting a hydrocarbon mixture having an initial boiling point of 30° C. to 70° C. with catalyst particles of a catalyst bed under reaction conditions effective to produce one or more olefins and/or one or more aromatics. In embodiments of the invention, the hydrocarbon mixture includes light naphtha (initial boiling point of 10° C. and final boiling point 70° C.), heavy naphtha (initial boiling point of 71° C. and final boiling point 200° C.), or full range naphtha (initial boiling point of 25° C. and final boiling point 204° C.). Non-limiting examples of the catalyst particles include ZSM-5, Y-Zeolite, Beta-Zeolite, SAPO-34, all zeolite and dual function catalyst with a “zeolite and metallic” composition, or combinations thereof. In embodiments of the invention, the catalyst particles may have a particle density of 800 to 1300 kg/m³ and all ranges and values there between including ranges of 800 to 900 kg/m³, 900 to 1000 kg/m³, 1000 to 1100 kg/m³, 1100 to 1200 kg/m³, and 1200 to 1300 kg/m³. In embodiments of the invention, the contacting at block 101 is conducted in a fluidized bed reactor. The fluidized bed reactor may comprise a fluidized catalyst bed having a catalyst fraction volume of 5 to 15% and all ranges and values there between including 5 to 6%, 6 to 7%, 7 to 8%, 8 to 9%, 9 to 10%, 10 to 11%, 11 to 12%, 12 to 13%, 13 to 14%, and 14 to 15%. The one or more olefins produced in the contacting step at block 101 may include light olefins comprising ethylene, propylene, 1-butene, 2-butene, isobutene, or combinations thereof. The one or more aromatics produced in the contacting step at block 101 may include benzene, toluene, xylene, or combinations thereof.

In embodiments of the invention, the fluidized bed reactor is a circulating fluidized bed reactor. The circulating fluidized bed reactor may have a fluidized bed having diameter to height ratio in a range of 0.05 to 3.6 and all ranges and values there between including ranges of 0.05 to 0.10, 0.10 to 0.20, 0.20 to 0.30, 0.30 to 0.40, 0.40 to 0.50, 0.50 to 0.60, 0.60 to 0.70, 0.70 to 0.80, 0.80 to 0.90, 0.90 to 1.0, 1.0 to 1.5, 1.5 to 2.0, 2.0 to 2.5, 2.5 to 3.0, and 3.0 to 3.6. In embodiments of the invention, the fluidized bed reactor includes one or more internal baffles disposed therein. The internal baffles may be configured to guide the catalyst particles and hydrocarbon in the fluidized bed reactor and control the back mixing in the fluidized bed reactor. In embodiments of the invention, the control of the back mixing in the fluidized bed reactor is configured to control light olefins to BTX ratio in a product stream from the fluidized bed reactor. The internal baffles may be further configured to improve gas distribution in the fluidized bed and improve contact between the catalyst particles and hydrocarbons. The internal baffles may be further configured to improve heat distribution in the catalyst bed.

According to embodiments of the invention, the reaction conditions at block 101 include a superficial gas velocity in the catalyst bed in a range of 2 to 7 m/s and all ranges and value there between including ranges of 2 to 3 m/s, 3 to 4 m/s, 4 to 5 m/s, 5 to 6 m/s, and 6 to 7 m/s. The reaction conditions at block 101 may include a residence time of 5 to 120 min (minutes) and all ranges and values there between including ranges of 5 to 10 min, 10 to 15 min, 15 to 20 min, 20 to 25 min, 25 to 30 min, 30 to 35 min, 35 to 40 min, 40 to 45 min, 45 to 50 min, 50 to 55 min, 55 to 60 min, 60 to 65 min, 65 to 70 min, 70 to 75 min, 75 to 80 min, 80 to 85 min, 85 to 90 min, 90 to 95 min, 95 to 100 min, 100 to 105 min, 105 to 110 min, 110 to 115 min, and 115 to 120 min. The reaction conditions at block 101 may further include a reaction temperature of 500 to 800° C. and all ranges and values there between including ranges of 500 to 510° C., 510 to 520° C., 520 to 530° C., 530 to 540° C., 540 to 550° C., 550 to 560° C., 560 to 570° C., 570 to 580° C., 580to 590° C., 590 to 600° C., 600 to 610° C., 610 to 620° C., 620 to 630° C., 630 to 640° C., 640 to 650 ° C., 650 to 660° C., 660 to 670° C., 670 to 680° C., 680 to 690° C., 690 to 700° C., 700 to 710° C., 710 to 720° C., 720 to 730° C., 730 to 740° C., 740 to 750° C., 750 to 760° C., 760 to 770° C., 770 to 780° C., 780 to 790° C., and 790 to 800° C. The reaction conditions at block 101 may further still include a reaction pressure of 0.9 to 3 atm and all ranges and values there between including ranges of 0.9 to 1.2 atm, 1.2 to 1.5 atm, 1.5 to 1.8 atm, 1.8 to 2.1 atm, 2.1 to 2.4 atm, 2.4 to 2.7 atm, 2.7 to 3.0 atm.

According to embodiments of the invention, method 100 includes determining coke content the catalyst bed, as shown in block 102. Coke content of the catalyst bed may increase with duration of the contacting step at block 101. According to embodiments of the invention, as shown in block 103, method 100 includes removing the catalyst particles from the reactor. At block 103, the catalyst particles can be transported from the reactor to a catalyst regenerator. In embodiments of the invention, the reactor is a fluidized bed reactor and the catalyst is separated from a reaction mixture comprising the products produced in the contacting step at block 101, prior to being transported to the catalyst regenerator. In embodiments of the invention, the reaction mixture and the catalyst are separated in a cyclone separation units comprising one or more cyclonic separators.

In embodiments of the invention, as shown in block 104, method 100 includes regenerating the catalyst particles, in response to coke content of the catalyst bed being at least 5 wt. %, preferably at least 10 wt. %, more preferably at least 15 wt. %, based on total weight of the catalyst. In embodiments of the invention, regenerating at block 104 includes flowing, under regenerating conditions, a regenerating gas through catalyst particles in the catalyst regenerator. The regenerating gas may include oxygen, air, or combinations thereof. At block 104, regenerating conditions may include a regenerating temperature of 550 to 850° C. and all ranges and values there between including ranges of 550 to 600° C., 600 to 650° C., 650 to 700° C., 700 to 750° C., 750 to 800° C., and 800 to 850° C. The regenerating conditions at block 104 may further include flowing regenerating gas on turbulent fluidization regime with less than 2 m/s velocity. In embodiments of the invention, the regenerating at block 104 may restore sufficient heat to the regenerated catalyst for catalytically cracking the hydrocarbon mixture at a reaction temperature of 500 to 800° C. The regenerated catalyst may be transported back to the reactor for catalytic cracking.

Although embodiments of the present invention have been described with reference to blocks of FIG. 1, it should be appreciated that operation of the present invention is not limited to the particular blocks and/or the particular order of the blocks illustrated in FIG. 1. Accordingly, embodiments of the invention may provide functionality as described herein using various blocks in a sequence different than that of FIG. 1.

The systems and processes described herein can also include various equipment that is not shown and is known to one of skill in the art of chemical processing. For example, some controllers, piping, computers, valves, pumps, heaters, thermocouples, pressure indicators, mixers, heat exchangers, and the like may not be shown.

In the context of the present invention, at least the following 13 embodiments are described. Embodiment 1 is a method of producing olefins and/or aromatics. The method includes contacting a hydrocarbon mixture having an initial boiling point of 30° C. to 70° C. with catalyst particles of a catalyst bed, in a reactor, under reaction conditions effective to produce ogle or more olefins and/or one or more aromatics. The method further includes regenerating the catalyst particles, in response to coke content of the catalyst bed being at least 5 wt. %. Embodiment 2 is the method of embodiment 1, wherein the catalyst is regenerated in response to coke content of the catalyst bed being at least 10 wt. %. Embodiment 3 is the method of either of embodiments 1 or 2, wherein the reaction conditions include a superficial gas velocity in a range of 2 to 7 m/s. Embodiment 4 is the method of any of embodiments 1 to 3, wherein the one or more olefins include ethylene, propylene, 1-butene, 2-butene, isobutene, or combinations thereof. Embodiment 5 is the method of any of embodiments 1 to 4, wherein the one or more aromatics include benzene, toluene, xylene, or combinations thereof. Embodiment 6 is the method of any of embodiments 1 to 5, further including, prior to the regenerating step, determining coke content of the catalyst bed, and removing the catalyst particles from the reactor. Embodiment 7 is the method of embodiment 6, wherein the regenerating includes flowing a regenerating gas containing oxygen to the regenerator. Embodiment 8 is the method of either of embodiments 6 or 7, wherein the regenerating is conducted at a regeneration temperature of 550 to 850° C. Embodiment 9 is the method of any of embodiments 1 to 8, wherein the catalyst bed includes a circulating fluidized catalyst bed. Embodiment 10 is the method of any of embodiments 1 to 9, wherein the catalyst bed has a diameter to height ratio in a range of 0.05 to 3.6. Embodiment 11 is the method of any of embodiments 1 to 10, wherein the reactor includes baffles therein configured to control back mixing in the catalyst bed. Embodiment 12 is the method of any of embodiments 1 to 11, wherein the reaction conditions include a residence time in a range of 5 to 120 minutes. Embodiment 13 is the method of any of embodiments 1 to 12, wherein the reaction conditions include a reaction temperature of 500 to 800° C. and a reaction pressure of 0.9 to 3 atm.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method of producing olefins and/or aromatics, the method comprising:
contacting a hydrocarbon mixture having an initial boiling point of 30° C. to 70° C. with catalyst particles of a catalyst bed, in a reactor, under reaction conditions effective to produce one or more olefins and/or one or more aromatics; and
regenerating the catalyst particles, in response to coke content of the catalyst bed being at least 5 wt. %.

2. The method of claim 1, wherein the catalyst is regenerated in response to coke content of the catalyst bed being at least 10 wt.

3. The method of 1, wherein the reaction conditions include a superficial gas velocity in a range of 2 to 7 m/s.

4. The method of 1, wherein the one or more olefins are selected from the group consisting of ethylene, propylene, 1-butene, 2-butene and isobutene, or combinations thereof.

5. The method of 1, wherein the one or more aromatics are selected from the group consisting of benzene, toluene and xylene, or combinations thereof.

6. The method of 1, further comprising:
prior to the regenerating step, determining coke content of the catalyst bed; and
removing the catalyst particles from the reactor.

7. The method of claim 6, wherein the regenerating comprises flowing a regenerating gas comprising oxygen to the regenerator.

8. The method of claim 6, wherein the regenerating is conducted at a regeneration temperature of 550 to 850° C.

9. The method of 1, wherein the catalyst bed includes a circulating fluidized catalyst bed.

10. The method of 1, wherein the catalyst bed has a diameter to height ratio in a range of 0.05 to 3.6.

11. The method of 1, wherein the reactor comprises baffles therein configured to control back mixing in the catalyst bed.

12. The method of 1, wherein the reaction conditions include a residence time in a range of 5 to 120 minutes.

13. The method of 1, wherein the reaction conditions include a reaction temperature of 500 to 800° C. and a reaction pressure of 0.9 to 3 atm.

14. The method of claim 2, wherein the catalyst bed includes a circulating fluidized catalyst bed.

15. The method of claim 2, wherein the catalyst bed has a diameter to height ratio in a range of 0.05 to 3.6.

16. The method of claim 2, wherein the reactor comprises baffles therein configured to control back mixing in the catalyst bed.

17. The method of claim 2, wherein the reaction conditions include a residence time in a range of 5 to 120 minutes.

18. The method of claim 2, wherein the reaction conditions include a reaction temperature of 500 to 800° C. and a reaction pressure of 0.9 to 3 atm.

19. The method of claim 1, wherein the reaction conditions include a reaction temperature of 500° C. and a reaction pressure of 3 atm.

20. The method of claim 1, wherein the reaction conditions include a reaction temperature of 800° C. and a reaction pressure of 0.9 atm.
